(19) United States
(12) Patent Application Publication
(10) Pub. No.: US 2012/0150394 A1
(43) Pub. Date: Jun. 14, 2012

(54) Operating System for a Folding Trailer

(75) Inventor: Michael A. Schwindaman, Cassopolis, MI (US)

(73) Assignee: Lippert Components Manufacturing, Inc., Goshen, IN (US)

(21) Appl. No.: 12/967,767

(22) Filed: Dec. 14, 2010

(51) Int. Cl. B62D 33/08

(52) U.S. Cl. 701/49; 296/26.04

(57) ABSTRACT

A system for extending and retracting a folding trailer. The trailer has a movable top extending from a base, and a plurality of extendible supports mounted on the base and connected to the top. A drive including an electric motor extends and retracts the extendible supports in unison to extend and retract the top. A controller is provided for the drive, the controller having a motor load monitor having both an ultimate load detector and a calculated load detector. In extending and retracting the top, the load of the electric motor is regularly monitored, and is first compared with an ultimate load threshold. The motor is stopped if the ultimate load threshold is met or exceeded. The monitored load is also compared with a stall load threshold, and the motor remains in operation until the stall load threshold is met or exceeded.

### BACKGROUND OF THE INVENTION

This invention relates to a folding camping trailer of the type having a movable top that closes over folding side walls and in particular to a system and method for extending and retracting the top, where the top, when extended, is extended sufficiently so that the folding side walls are tight.

Folding camping trailers have existed for many years. U.S. Pat. Nos. 3,981,529 and 7,090,281 are examples of such trailers. U.S. Pat. No. 4,299,421 is directed to a telescoping post support for a trailer.

U.S. Pat. No. 5,505,515, the disclosure of which is incorporated herein by reference, discloses a further folding trailer with a hydraulic means of lifting and retracting a rigid top member. Via a series of pulleys and cables operated by the hydraulic system, the top is either extended or retracted.

Prior systems that have used power to raise and lower the movable top of a folding trailer typically use a series of limit switches to determine the limits of upward and downward movement. However, many problems exist with this type of control. Due to variances in temperature and humidity, the canvas used in a folding trailer may stretch considerably on one given day, but much less on another. Since the prior art has no means to compensate for this, the prior art necessarily needs to set what can be considered to be a safe opening to accommodate the least possible stretch in order to avoid inadvertently tearing the canvas. That means that, in most instances, the canvas is not stretched taut most of the time, resulting in a very unpleasing appearance.

### SUMMARY OF THE INVENTION

The invention is directed to a system for extending and retracting a folding trailer. The trailer includes a movable top connected to and supported on a base. A plurality of extendable supports is mounted on the base and connected to the top. A drive is provided for extending and retracting the extendable supports in unison to extend and retract the top above the base, with the drive including an electric motor. A controller is provided for the drive, with the controller having a motor load monitor. The monitor includes an ultimate load detector and a calculated load detector.

In accordance with the invention, the drive further includes a lead screw connected to be driven by the motor, and a cable operator mounted on the lead screw. The cable operator is also mounted on a trolley, and the trolley is mounted on an elongated support. The support includes opposite rails, with the trolley including wheels engaged in the rails. The trolley includes a pair of spaced beams to which the wheels are mounted.

The invention also includes a method of extending and retracting the folding trailer. The method comprises the steps of activating the electric motor, and then periodically and regularly calculating load on the electric motor. The calculated load is periodically and regularly compared with an ultimate load threshold. The motor is deactivated if the calculated load meets or exceeds the ultimate load threshold. The calculated load is also periodically and regularly compared with a stall load threshold, and once the calculated load meets or exceeds the stall load threshold, the electric motor is deactivated.

The ultimate load threshold comprises a maximum load that the motor is to withstand. The stall load threshold comprises a load greater than an average load withstood by the motor, and represents a desired extension of the top. In all instances, the ultimate load threshold is greater than the calculated load threshold.

### BRIEF DESCRIPTION OF THE DRAWINGS

The invention is described in greater detail in the following description of an example embodying the best mode of the invention, taken in conjunction with the drawing figures, in which:

FIG. 1 is an isometric view of a portion of a folding trailer of the nature of the invention, but having a prior art manual extending and retracting mechanism,

FIG. 2 is an isometric view of the electric drive system of the invention, with the cable operator in a first position,

FIG. 3 is a view similar to FIG. 2, but with the cable operator in a second position,

FIG. 4 is a view similar to FIGS. 2 and 3, but with the cable operator in a third position,

FIG. 5 is an enlarged partial elevational view of the cable operator engaged on its elongated support,

FIG. 6 is a block diagram of the method of extending a folding trailer top, and

FIG. 7 is a block diagram of a method for retracting the folding trailer top.

### DESCRIPTION OF EXAMPLES EMBODYING THE BEST MODE OF THE INVENTION

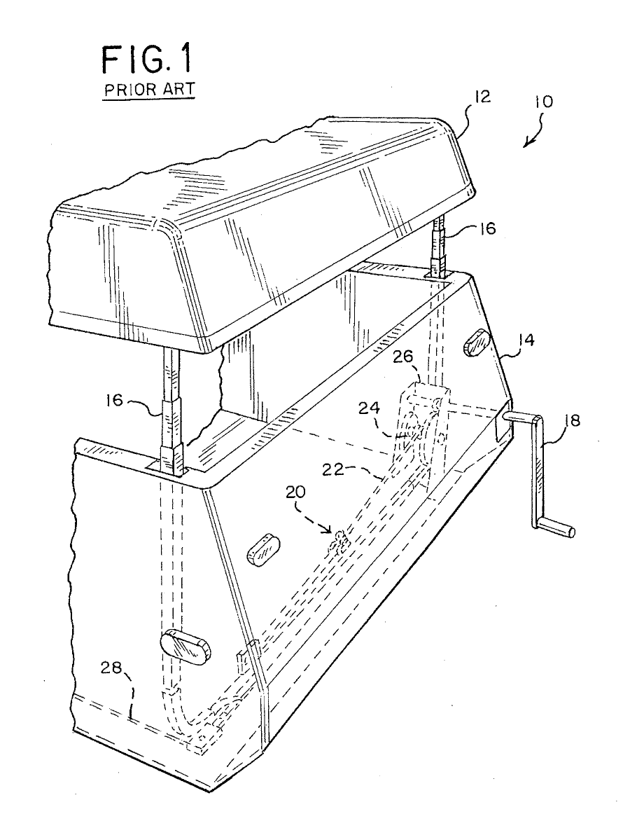

FIG. 1 illustrates a prior art system for extending and retracting a folding trailer, in which the top is raised and lowered manually, but having elements also employed in the present invention, as described in greater detail below. Illustrated is a folding trailer 10 which comprises a movable top 12 that is connected to and supported on a base 14. The base 14, in turn, is mounted for transportation on wheels (not illustrated), and is also provided with an appropriate hitch or other means (also not illustrated) for it to be transported from one location to another, all of which is conventional and therefore not described in further detail.

A plurality of extendable supports 16 is mounted on the base 14 and connected to the movable top 12. Preferably, one of the supports 16 is located proximate each of the four corners of the base 14, although for a larger structure, additional extendable supports 16 can be employed.

The extendable supports 16 may be as illustrated and described in incorporated U.S. Pat. No. 5,505,515 using a pulley and cable system for raising and lowering. Other types of supports, however, can also be employed.

For raising and lowering the top 12 in the prior art system shown in FIG. 1, a conventional drive is provided, operated by means of a hand crank 18. The hand crank 18 is connected to a cable and pulley system 20, where a main operating cable 22 is wound on a spool 24 rotated by the hand crank 18. The spool 24 and hand crank 18 are appropriately mounted in a bracket assembly 26. For raising and lowering the extendable supports 16 at the opposite end of the base 14, a transfer cable 28 is provided, also operated by the hand crank 18. Typical positioning of four of the extendable supports 16 is shown in incorporated U.S. Pat. No. 5,505,515.

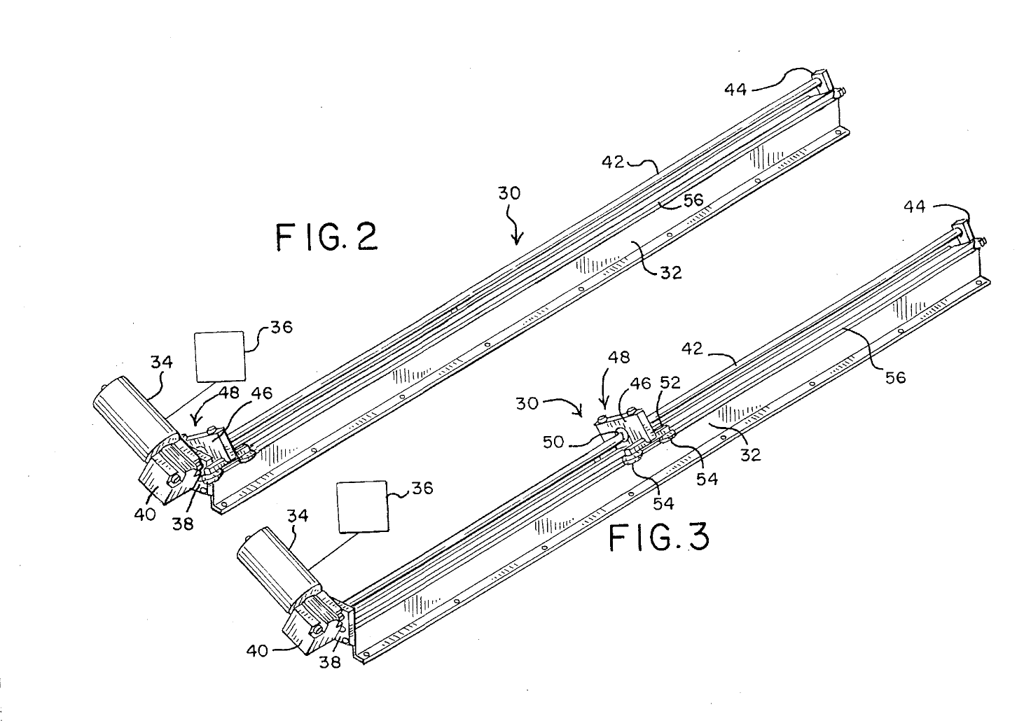

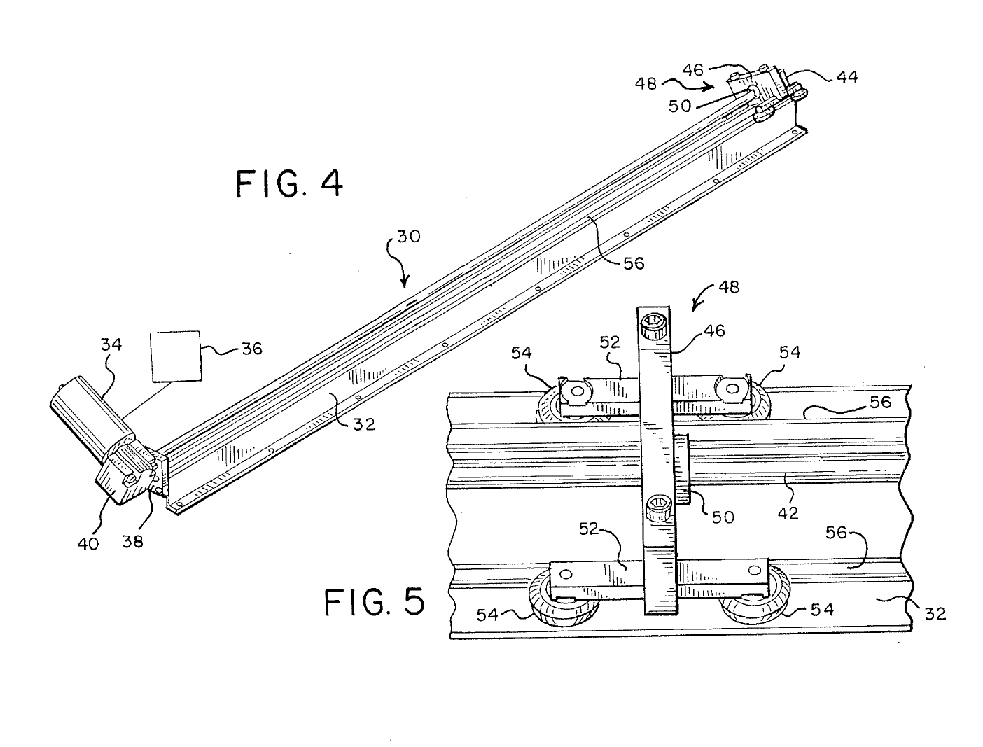

The present invention, in one form, employs a cable and pulley system like the cable and pulley system 20, but without a manual hand crank, such as the hand crank 18. Instead, the invention employs a drive 30 as illustrated in FIGS. 2 through 4. The drive 30 is mounted between the extendable supports 16 with the cable and pulley system 20 connected thereto, as described in greater detail below.

The drive 30 includes an elongated support 32, an electric motor 34, and a controller 36. As illustrated, the motor 34 is mounted on a bracket 38 located at one end of the elongated support 32.

The motor 34 includes a conventional gear assembly 40 that drives a lead screw 42. The lead screw 42 is mounted in a bearing 44 at one end of the elongated support 32 and in a similar bearing (not illustrated) in the bracket 38. The lead screw 42 may therefore be rotated in its bearings by the motor 34 through the gear assembly 40.

A cable operator 46 is mounted on the lead screw 42 for movement to and fro along the elongated support 32. The cable operator 46 is mounted on a trolley 48 on the elongated support 32. As illustrated, the cable operator 46 comprises a flat plate having a central bearing 50 engaged on the lead screw 42. The cable operator 46 is connected to a pair of spaced beam 52, each beam 52 supporting a pair of wheels 54. The wheels 54 of each beam 52 engage opposite rails 56 formed in the elongated support 32. The cables of the cable and pulley system 20 are, in turn, secured to the cable operator 46 so that when the cable operator 46 is driven in one direction, the movable top 12 is extended, and when the cable operator 46 is driven in the opposite direction, the movable top 12 is retracted.

The controller 36 is preferably a special purpose computer or the like which is connected for operation of the motor 34. The controller 36 includes an ultimate load detector 56 and a calculated load detector 58, both connected to the motor 34.

During operation of the motor 34 to raise and lower the top 12, the motor experiences an electrical load as the top 12 is raised and lowered. This load is calculated at regular intervals, and is designated the calculated load. The maximum load is the greatest load that the motor 34 is typically able to withstand, and is that load in the ultimate load detector 56. The stall load, on the other hand, comprises a load greater than the usual and calculated load of the motor 34 as the top 12 is raised, and is the load that the motor 34 experiences once it has raised the top 12 to a desired extension with the side fabric of the trailer 10 taut. The stall load is provided in the calculated load detector 58. The ultimate load threshold is greater than the calculated load, and is typically not experienced. However, if the top 12 encounters an obstruction, the motor 34 will quickly experience its ultimate load threshold, and the ultimate load detector stops the motor to prevent the motor 34 from being damaged or destroyed.

The present invention automatically allows for a desired stretch of the canvas, no matter what the load on the top 12 may be, so long as the ultimate load threshold is not exceeded. Thus, expansion, contraction and stretch of the canvas over time are accommodated by not setting a limit of travel, but rather calculating the load on the motor 34. Accessories can be placed on the top 12, such as air conditioners, bicycles and luggage, and the top 12 can be raised so long as the calculated load does not meet or exceed the ultimate load threshold.

Just as an example, the top 12 may require 250 pounds of force, normally, to raise it, and to stretch the canvas sufficiently taut, another 100 pounds of force can exerted, resulting in a total of 350 pounds of force comprising the stall load. Any load experienced at or above the stall load would then cause the motor 34 to be deactivated. If additional weight is added to the top 12, however, such as an air conditioner and luggage, it may now require 500 pounds of force to raise the top 12, plus 100 pounds of force to stretch the canvas taut, for a total of 600 pounds at the stall load. Thus, as the motor 34 is activated, the load is constantly calculated at regular intervals, and the roof is raised or lowered until the stall load is reached. In all instances, the desired stretch of the canvas is accommodated and weight is automatically compensated without any input from the person raising or lowering the top 12.

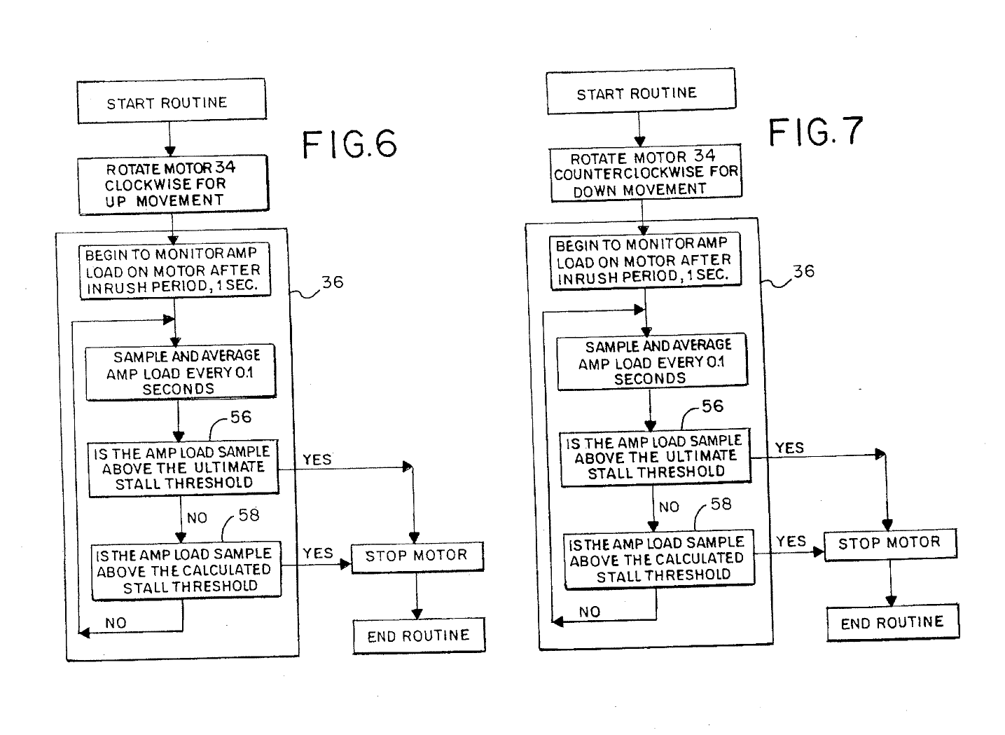

The routine for operating the invention is shown in FIGS. 6 and 7, with FIG. 6 illustrating the routine for raising the top 12, and FIG. 7 illustrating the routine for lowering the top 12.

In operation, the motor 34 is first rotated in one direction, such as the clockwise direction for rotating the lead screw 42, for extending the top 12. The controller 36 monitors the load on the motor 12 periodically and regularly, such as every tenth of a second, as the motor 34 is operated. The monitor load is compared with the ultimate load threshold and if that threshold is not reached, raising or lowering of the top 12 continues. However, if the ultimate load is met or exceeded, the electric motor 34 is then deactivated, and the extending or retracting of the top 12 ceases.

If the ultimate load threshold is not exceeded, however, extension or retraction of the top 12 continues. The load is sampled periodically, such as every 0.1 seconds, and the calculated load of the motor 34 is quickly established. The stall load is then known and the calculated load is constantly compared with the stall load threshold. So long as the stall load threshold is not met or exceeded, the extension or retraction of the top 12 continues.

Once the top 12 reaches its extent of travel, the motor 34 quickly experiences an increased load, and once the stall load threshold is met or exceeded, the controller 36 stops the motor. Similarly, during retraction, once the top 12 is seated on the base 14, the load of the motor 34 quickly increases. When the stall load threshold is experienced, the calculated load detector 58 then stops the motor 34.

Thus, extension and retraction of the top 12 by the motor 34 normally proceeds in either direction until the stall load threshold is experienced. If, however, an obstruction is encountered before the top 12 is fully extended or retracted, the ultimate load threshold is quickly detected, and the motor 34 is deactivated.

The invention provides an improved means of raising or lowering a movable top 12. Because the stall load threshold is always set in the controller 36, a desired amount of tautness of the fabric of trailer 10 can be achieved, giving the trailer 10 an improved, trim look when the top 12 is extended.

Various changes can be made to the invention without departing from the spirit thereof or scope of the following claims.

What is claimed is:

1. A system for extending and retracting a folding trailer, comprising
a. a movable top connected to and supported on a base,
b. a plurality of extendable supports mounted on the base and connected to the top,
c. a drive for extending and retracting said extendable supports in unison to extend and retract said top above said base, said drive including an electric motor, and
d. a controller for said drive, said controller having a motor load monitor, said monitor including an ultimate load detector and a calculated load detector.

2. The system according to claim 1, in which said drive further includes a lead screw connected to be driven by said motor, and a cable operator mounted on said lead screw.

3. The system according to claim 2, in which said cable operator is mounted on a trolley.

4. The system according to claim 3, in which said trolley is mounted on an elongated support.

5. The system according to claim 4, in which said support includes opposite rails, said trolley including wheels engaging said rails.

6. The system according to claim 3, in which said trolley includes a pair of spaced beams.

7. The system according to claim 1, in which said drive includes a lead screw connected to said motor.

8. The system according to claim 7, in which said motor is bi-directional.

9. The system according to claim 7, including a cable operator mounted on said lead screw for translation.

10. The system according to claim 9, in which said cable operator is located on an elongated support.

11. The system according to claim 10, in which said elongated support includes opposite spaced rails, and said cable operator includes at least one wheel engaged in each rail.

12. A method of extending and retracting a folding trailer, in which the trailer includes a movable top connected to and supported on a base, a plurality of extendable supports mounted between said base and said top, and an electric motor connected for extending and retracting said extendable supports, the method comprising the steps of
a. activating the electric motor,
b. periodically and regularly calculating load on the electric motor,
c. comparing the calculated load with an ultimate load threshold,
d. de-activating the electric motor if the calculated load meets or exceeds the ultimate load threshold,
e. comparing the monitored load with a stall load threshold,
f. repeating steps b-e until the calculated load meets or exceeds the stall load threshold, and
g. de-activating the electric motor when the monitored load meets or exceeds the stall load threshold.

13. The method according to claim 12, in which the ultimate load threshold comprises a maximum load the motor is to withstand.

14. The method according to claim 12, in which the stall load threshold comprises a load greater than an average calculated load withstood by the motor.

15. The method according to claim 14, in which the stall load threshold represents a desired extension of the top.

16. The method according to claim 12, in which said ultimate load threshold is greater than said stall load threshold.
